(19) United States
(12) Patent Application Publication
(10) Pub. No.: US 2002/0133728 A1
(43) Pub. Date: Sep. 19, 2002

(54) Network traffic based adaptive power management system for computer networks

(76) Inventor: Sanjay Agarwal, Santa Clara, CA (US)

Correspondence Address: SANJAY AGARWAL, CHIPSOL, Inc., 4702 CHEENEY STREET, SANTA CLARA, CA, 95054, US

(21) Appl. No.: 09/760,686

(22) Filed: Jan. 16, 2001

Related U.S. Application Data
(60) Provisional application No. 60/248,951, filed on Nov. 14, 2000.

(51) Int. Cl. G06F 1/26; G06F 1/28; G06F 1/30

(52) U.S. Cl. 713/324

(57) ABSTRACT

A method for power management and energy conservation in computer networking equipment uses the information on network traffic intensity. The cooling and ventilation provided is directly proportional to network traffic intensity. The traffic intensity information is conveyed to the power management processor, which uses pulse width modulation (PWM) to control cooling and ventilation fans in the equipment. Traffic intensity is proportional to the switching activity in integrated circuits. Switching activity in integrated circuits is proportional to the heat generation in integrated circuits. Higher traffic intensity results in higher heat generation, which correspondingly results in higher cooling and ventilation requirements. The cooling and ventilation should adapt dynamically to the requirements of the system. This adaptation and optimal application of cooling and ventilation in networking equipment provides reduction in power usage in the system equipment. The function of power management processor can be outside of the existing integrated circuits electronics or alternatively can be designed within one of the existing integrated circuits. Control of cooling and ventilation system will also provide reduction in noise levels within the networking equipment facility. This power management invention can also be applied to Storage Area Network (SAN) networking equipment and wireless networking equipment, which is part of the network computing system. The invention can also be deployed in a heterogeneous network comprising of a combination of wired networking, storage area network, and wireless network.

### CROSS-REFERENCE TO RELATED APPLICATIONS

This application is entitled to the benefit of Provisional Patent Application Ser. 60/248,951, filed Nov. 14, 2000.

### STATEMENT REGARDING FEDERALLY SPONSORED RESEARCH AND DEVELOPMENT

Not Applicable.

### SEQUENCE LISTING

Not applicable.

### REFERENCE TO A MICROFICHE APPENDIX

Not Applicable.

### BACKGROUND OF THE INVENTION

The present invention relates generally to power management of computer networks equipment, and more particularly, for optimizing power management based on traffic through the network as applied to the cooling and ventilation system of the equipment. The present invention is related to U.S. patent classification definitions 713/323, and 713/324.

Computer networking equipments form the backbone for transfer of electronic information over variety of transfer medium that includes copper cable, optical fiber, and air for wireless data transfer. Before traveling over the transfer medium, the information is processed in the electronic form in the integrated circuits. The current rate or speed of information transfer is in the range of 10 megabits per second, 100 megabits per second, 1000 megabits per second, and 10 gigabits per second (megabit=1000,000 bits, gigabit=1,000,000,000 bits), and increasing. The speed requirements are increasing and so are the switching requirements of the integrated circuits that drive the data. Higher traffic in the computer networks results in higher switching capacity, which results in higher amount of power consumption by the integrated circuits. The power consumed by the integrated circuit is directly proportional to the frequency of switching (described, for example in Neil Weste and Kamran Eshraghian, Principles of CMOS VLSI Design—A Systems Perspective, Addison-Wesley Publishing Company, 1988, at pages147-149, which is hereby incorporated by reference). Higher amounts of data correspond to higher amounts of switching activity within the integrated circuits. In effect, the power consumed by the integrated circuits is directly proportional to the amount of data that travels through the network. Electrical power consumed by the electronic components is in proportion to the heat generation of each of the components. Hence, the heat generation is directly proportional to the switching activity within the integrated circuit. The networking equipment is designed with ventilation and cooling system that removes the generated heat. A significant amount of power in the computer networking equipment is consumed by the ventilating system that keeps the integrated circuits cooled and in working condition. The optimal amount of cooling should be directly proportional to the amount of heat generated by the integrated circuits or the switching requirements of the integrated circuits.

Computer networking equipment continues to be the most extensive energy consumers placing considerable strain on the existing power supply systems. This strain on power supply systems extends from power used by individual companies to the power generation system of the utilities. The article in San Jose Mercury News dated Jan. 7, 2000 titled “California Energy Crisis—State targets power suppliers for refunds” discusses the strain on electrical utility systems in the state of California. On page 20A of the news article, the article indicates that a Silicon Valley “server farm”—a building that houses hundreds of internet computers—can consume more than 200 megawatts of power a day. The article further indicates that 200 megawatts is more than 100 times the power consumption of a typical high-rise office building. Energy conservation to any extent in the computer networking equipment can help the utility system.

Inventors have created several system designs and solutions to achieve optimal power management in computer systems. Some of the methods and apparatus are as follows:

The computer equipment industry has a variety of schemes for controlling electrical power. U.S. Pat. No. 4,312,035 (1982) assigned to Richard E. Greene is an invention on apparatus for controlling electrical power in a data processing system. The patent describes a central control, monitor, and metering of application of voltage and time to each separate unit. This invention also includes a circuit for sequentially connecting the voltage signals to the peripherals. The invention describes how a central system can be configured to selectively control power application to independent power consuming peripheral units. The block diagram for this invention is described in FIG. 1. This invention ignores activity within the integrated circuit components as the basis for conserving power. This invention does not indicate any power saving method for controlling the power usage in cooling and ventilation system.

Power management can also be achieved by monitoring inactivity of input/output devices. U.S. Pat. No. 6,128,745 (2000) assigned to Eric Christopher Anderson, and Henri Hayim Farhi describes power management inactivity monitoring using software threads. The patent describes assignment of individual timers to each input/output devices and then software monitoring of timers for time-out. In the event of time-out, the specific input/output device driver is sent a power reduction instruction. This invention configures devices to be in either power-save or active-mode based on timer elapsing. The flow chart diagram for this invention is as shown in FIG. 2. This invention does not discuss power management in the context of switching activity of integrated circuit components. This invention does not indicate any power saving method for controlling the power usage in cooling and ventilation system.

In U.S. Pat. No. 6,105,142 (2000) assigned to Lonnie C. Goff et al., we have a description on intelligent power management interface for computer system hardware. The patent describes power management in the context of Advanced Configuration and Power Interface (ACPI). The invention describes introduction of a power management processor. The objective of introduction of power management processor in this invention is to let the operating system perform routine power management functions. The power management processor implements sophisticated power management functions. The power savings is achieved by letting individual devices go into sleep-mode or active-mode depending on the activity status at any given time. The architectural diagram for this invention is as shown in FIG. 3. This invention discusses the introduction of power management processor in the ACPI environment.

Power management and heat dissipation inside the system has always been a concern to system designers. U.S. Pat. No. 6,101,610 (2000) assigned to William Eldred Beebe, and John Daniel Upton describe s a computer system having thermal sensing with dual voltage sources for sensor stabilization. The computer system described employs a thermal sensor in the main CPU housing to detect operating temperatures. The computer system is then designed to get into an orderly shut down mode if the sensors detect that a pre-defined operating temperature has been crossed in the computer system. This invention uses a thermal sensor for detecting the trip point based on high temperatures in the CPU housing. Thermal sensors are expensive and require costly analog circuitry for precise detection system. The electrical diagram for this invention is described in FIG. 4. This invention uses thermal sensors as a means to determine condition of the components inside the equipment. This invention does not indicate any power saving method for controlling the power usage in cooling and ventilation system.

Power management can also be achieved by detecting on-hook and off-hook status for the computer system integrated with telephone systems. U.S. Pat. No. 5,958,055 (1999) assigned to David R. Evoy et al, describes this invention. The invention describes power management unit to detect on-hook or off-hook status of telephone to put the computer into either normal power mode or power saving mode. The block diagram for this invention is as shown in FIG. 5. This invention does not take into consideration the level of traffic or usage of the components that make the system equipment.

Power management is also an issue in portable computing systems. U.S. Pat. No. 5,954,820 (1999) assigned to Steven Robert Hetzler describes portable computer with adaptive demand-driven power management. This invention describes the method for managing power in a portable computer using past history of the various electrically powered computer components and a prediction of future user demands to determine power-save mode entry and exit conditions. The block diagram for this invention depicting power source and various energy-consuming components is as shown in FIG. 6. This invention utilizes historical data and a prediction of usage data to put individual components in power-save or exit-mode.

The invention described in U.S. Pat. No. 5,913,067 (1999) assigned to Dean A. Klein describes a system to manage power in the computer system based on activity at a particular IO device, and managing the idle timers associated with expiration times for each device. Upon expiration of the associated device idle timer, the system puts the I/O device in powered-down state. In this invention the power management is accomplished by switching devices on and off to optimize power. This invention as an apparatus for adaptive power management is described in FIG. 7. This invention uses timer-based system to put devices in power down modes based on the activity in the IO device.

The power management system design focus is monitoring the in-activity of different peripheral and input output devices and selectively putting the components in sleep mode. The current industry standard for system design in computer networking boxes is to provide a fixed constant amount of cooling and ventilation, which requires a constant operation of the fan system. This cooling and ventilation is used for removal of heat from inside of the networking equipment. This also results in constant noise generation in the proximity of the networking equipment.

Accordingly, the prior art power management systems ignore power savings that can be obtained based on using network traffic intensity data for controlling the cooling and ventilation systems in computer networking equipment. The power management systems of prior art also ignore the reduction in noise levels that can be achieved in computing environments if we can adaptively control the cooling systems based on network traffic levels.

### BRIEF SUMMARY OF THE INVENTION

The present invention monitors the amount of data flowing through the system and adaptively controls the cooling and ventilation requirements based on the amount of network traffic. Control of cooling and ventilation systems power provides energy conservation for the complete system. The cooling and ventilation systems in the computer networking equipment are designed around mechanical fans. These fans supply the needed cooling air to keep the individual electronic components in working condition. At the same time, these fans are powered from the system power supply unit. The cooling fans themselves contribute to the power usage inside the networking equipment. This invention describes controlling the cooling requirements based on levels of network traffic to optimize the power consumed by the cooling fans. The invention also describes a cost-effective all digital system to achieve power management in cooling system design. The invention described here monitors the quantity of data traffic over the computer networks and uses the principles of pulse width modulation (PWM). The system then applies adaptive cooling and ventilation management in the computer networking equipment to achieve optimal power consumed by the networking equipment. The objective of the invention is to achieve energy conservation in networking equipment using cost-effective means.

### BRIEF DESCRIPTION OF THE SEVERAL VIEWS OF THE DRAWING

The features believed to be characteristic of this invention are set forth in the appended claims. The invention itself however, as well as further objects and advantages thereof, will best be understood by reference to the following detailed description of an illustrative embodiment, when read in conjunction with the accompanying drawings, wherein:

FIG. 1 is prior art and is a block diagram of a data processing system.

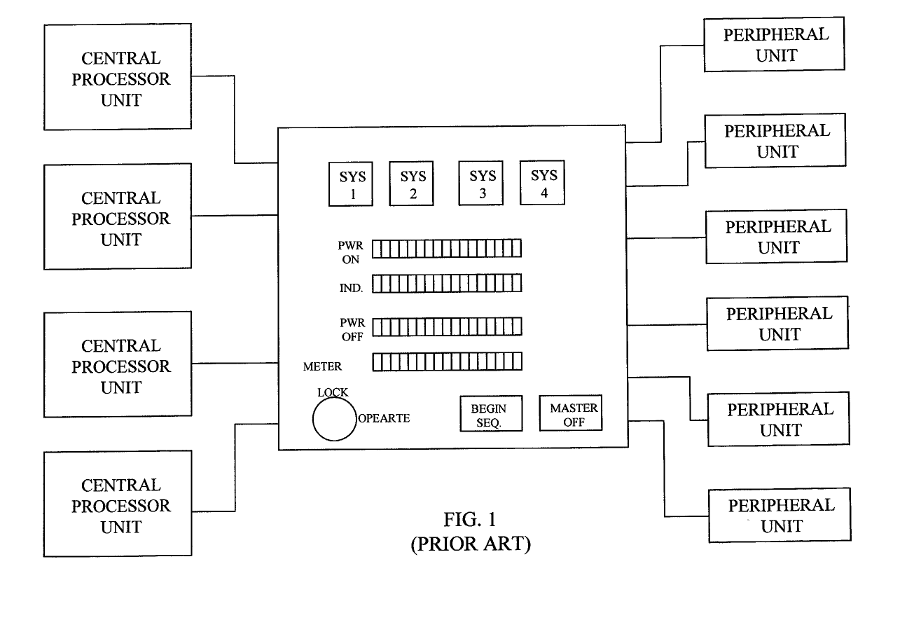

FIG. 2 is prior art and is a flow chart diagram of a timer-based power management system.

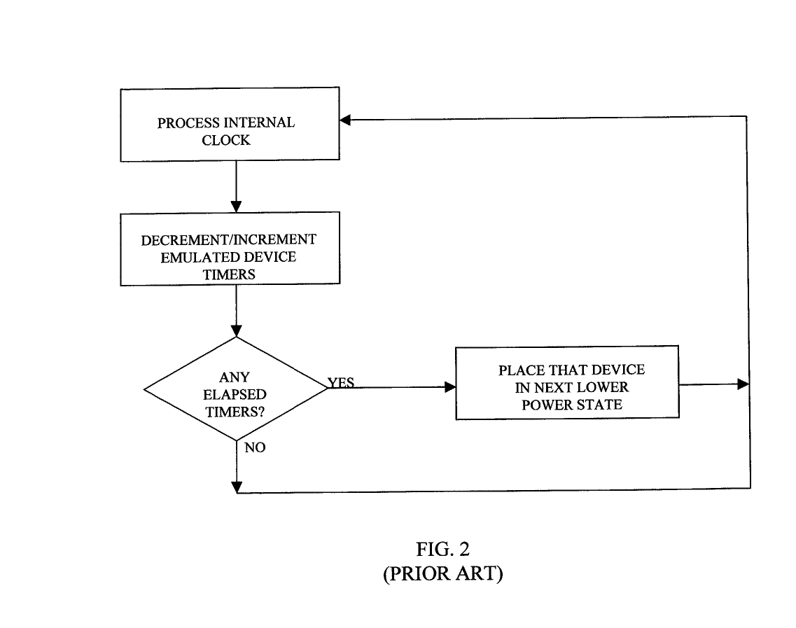

FIG. 3 is prior art and is an architectural diagram illustrating the relationship of the software and hardware components.

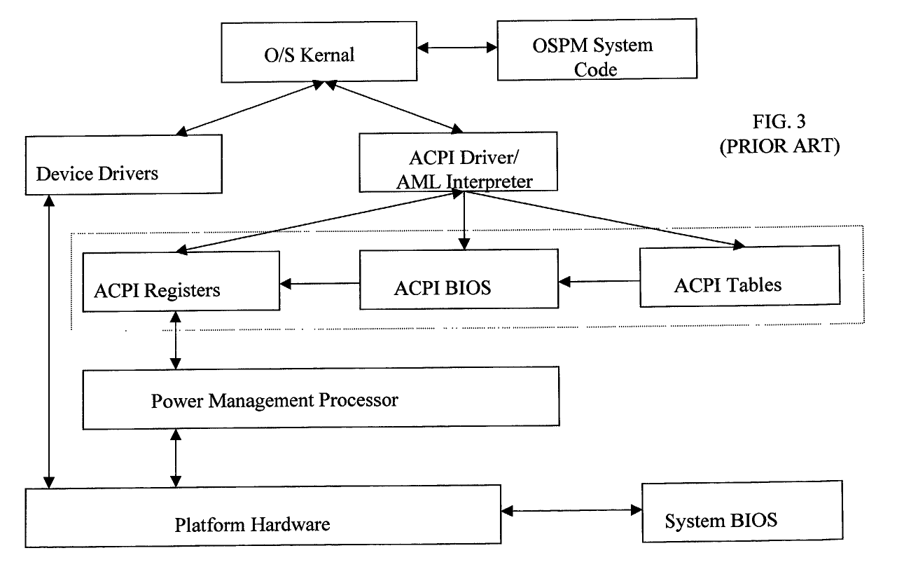

FIG. 4 is prior art and is an electrical diagram in block form of a computer system.

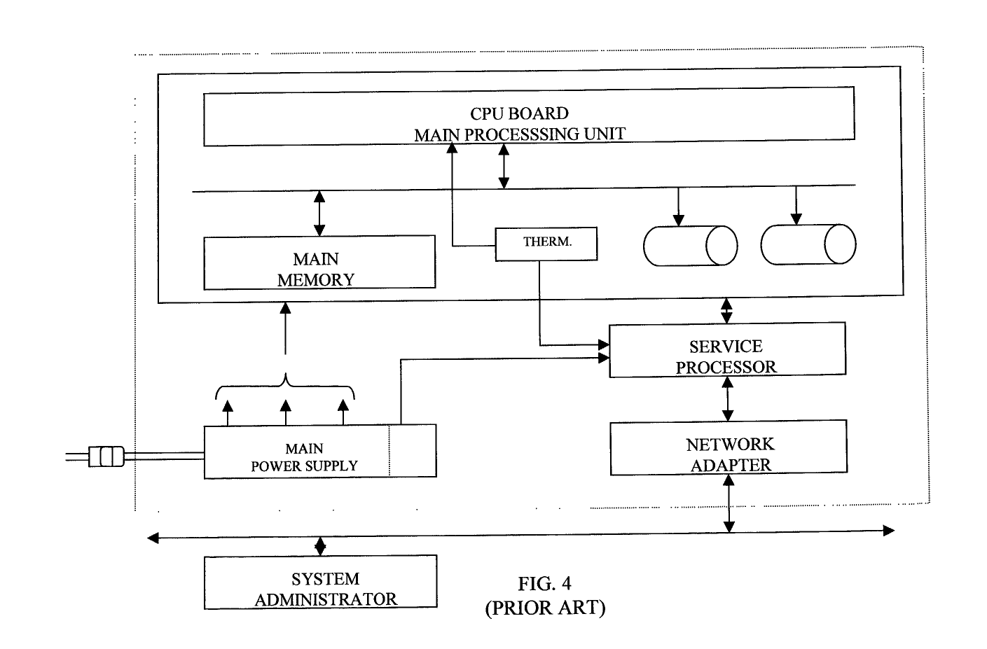

FIG. 5 is prior art and is a block diagram of a computer system with telephone system.

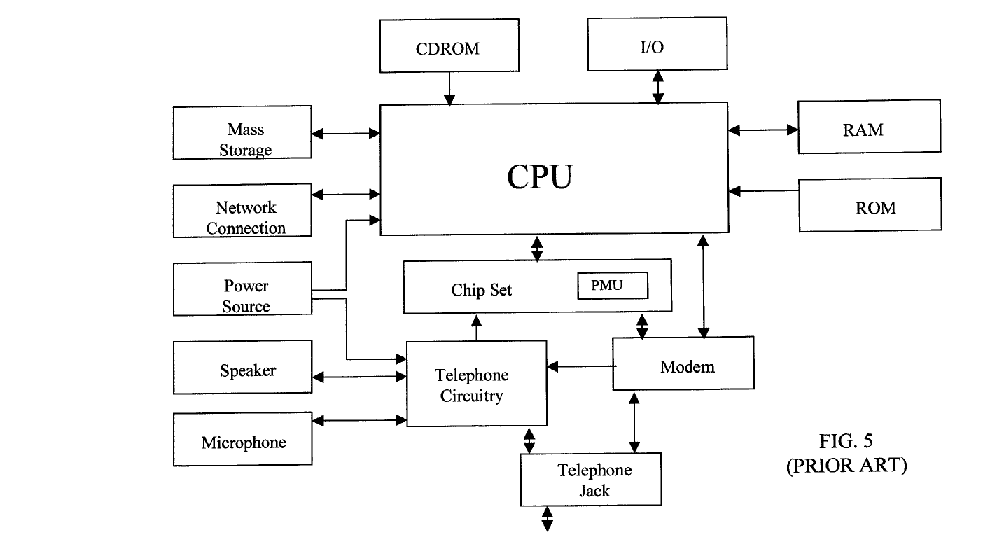

FIG. 6 is prior art and is a block diagram of the computer system illustrating the power source and the various energy-consuming components.

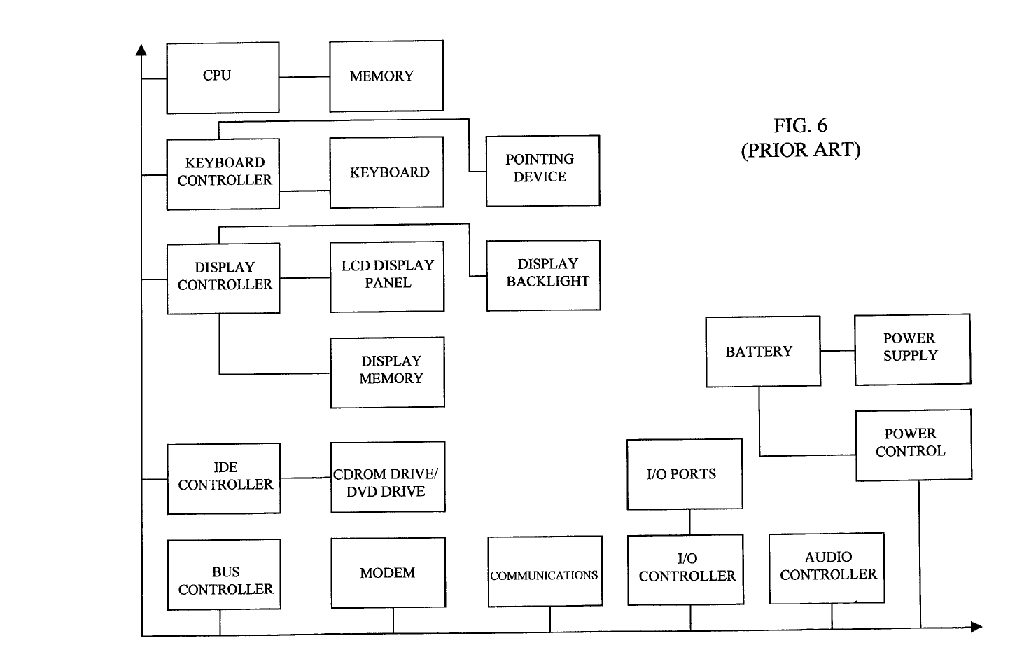

FIG. 7 is prior art and is a block diagram of a computer system with adaptive power management.

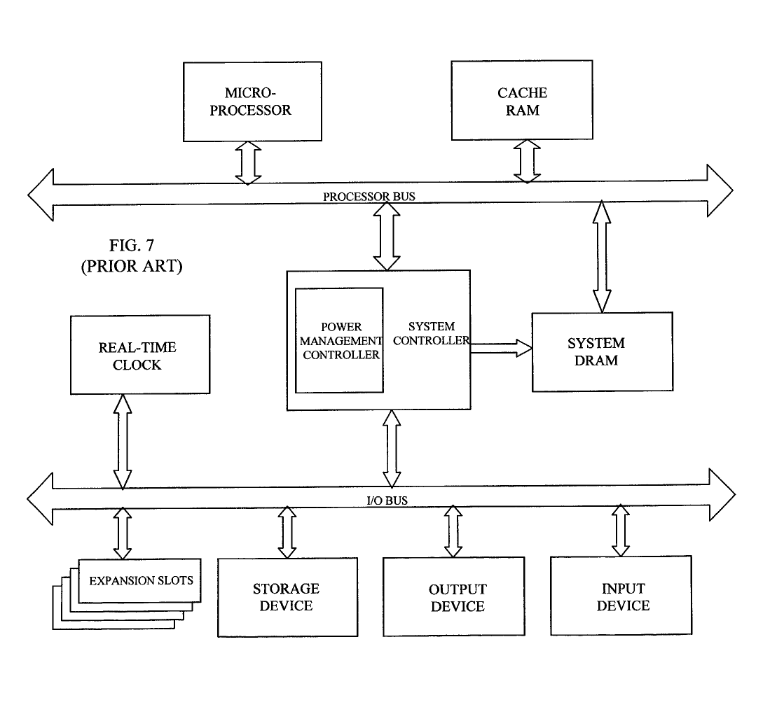

FIG. 8 is a block diagram of System description for power management in accordance with the present invention; and

FIG. 9 is a representation of Pulse Width Modulation (PWM) Link Signals in accordance with the present invention; and

FIG. 10 is the structure for Communications Link Interface used in the system described in FIG. 8 in accordance with the present invention; and

FIG. 11 is the plot of Internet traffic Index in accordance with the present invention.

### REFERENCE NUMERALS IN DRAWINGS

| | |
|---|---|
| 102 computer networking equipment | 104 power management processor |
| 106 cooling fan 1 | 108 cooling fan 2 |
| 110 cooling fan 3 | 112 cooling fan 4 |
| 114 power management processor | 116 PWM (pulse width |
| | modulation) link |
| 118 cooling fan A | 120 options A, B, C, D |
| 122 networking equipment | 124 register m |
| 126 register k | 128 power management processor |
| 130 communications link | 132 global traffic index |

### DETAILED DESCRIPTION OF THE INVENTION

The accompanying drawings, which are incorporated into and form a part of the specification, illustrate several embodiments of the present invention and, together with the description, serve to explain the principles of the invention. The drawings are only for the purpose of illustrating a preferred embodiment of the invention and are not to be construed as limiting the invention. In the drawings:

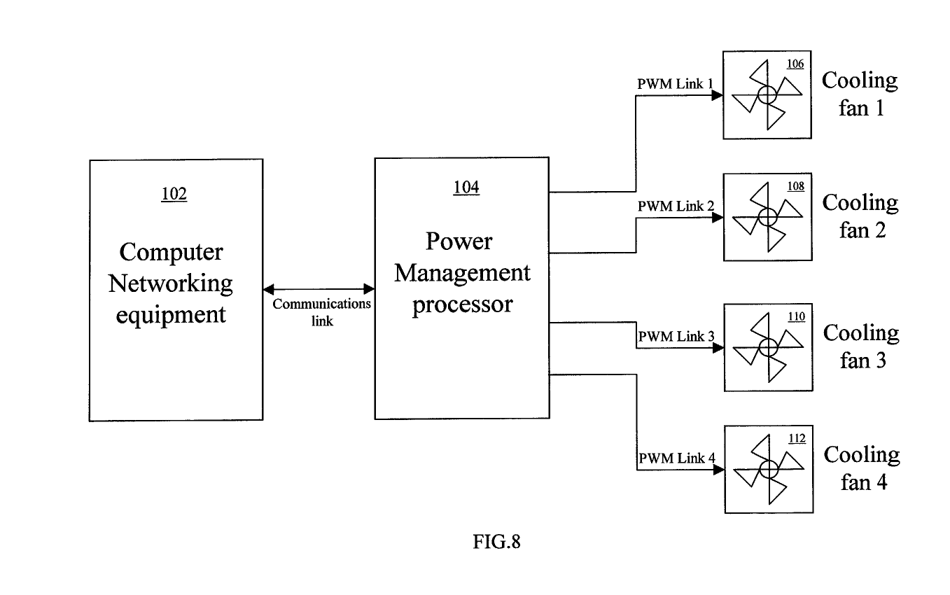

FIG. 8 is System description for power management system. The figure illustrates a configuration for a power management system with computer networking equipment 102. A power management processor 104 controls the speed and operation of the cooling ventilation fan systems 106 108 110 112. A given network router can have ventilation fans located at different places based on the placement of the integrated circuits. Preferably, the ventilation fans are situated close to the heat generating devices. The figure illustrates 4 cooling fans but the systems can have higher or fewer cooling fans depending on the cooling requirements.

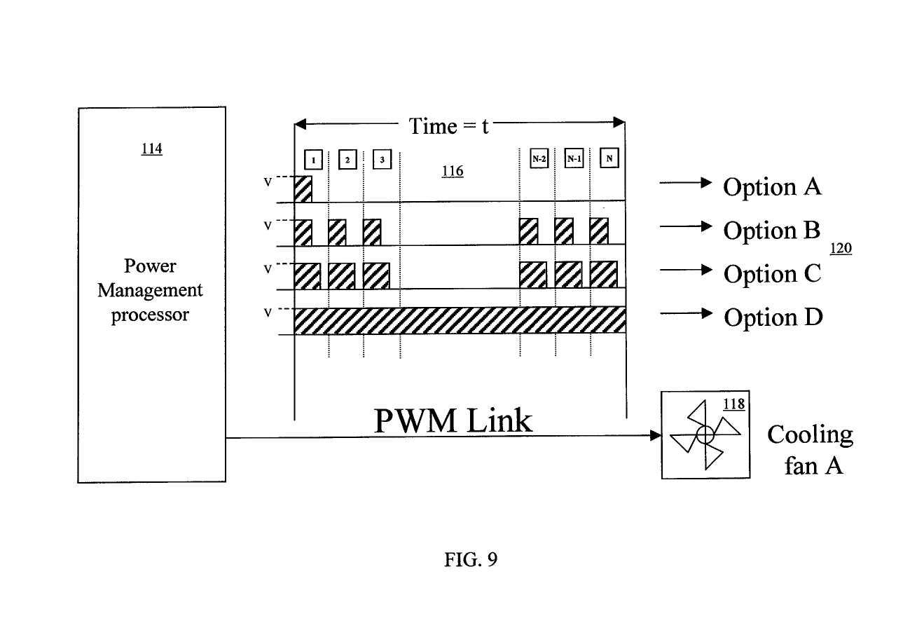

FIG. 9 is Pulse Width Modulation (PWM) Link. The figure illustrates the control mechanism for the control of cooling fan A. Different pulse width modulated waveforms can be generated using power management processor 114. Pulse width 116 of the applied waveform results in the drive states of the cooling fans 118. The width of the pulse applied in any given time slot is a function of the power consumed by the cooling and ventilation system. Different options 120 of waveforms can be applied to the voltage terminals of the cooling fan in any given time slot Time=t. The power consumed by any electronic device is a product of applied voltage and current in the device over the time period t. The shaded area in the graph of pulse waveforms 116 for different waveform options is illustrating the power consumed in the device for different options 120. Different options illustrated are Option A, Option B, Option C, and Option D. Depending on observed traffic, different options can be applied to keep the fan in drive condition. Option A can be selected for the lowest amount of traffic and Option D can be selected for the highest amount of traffic. Option B and Option C can be used for other intermediate intensities of traffic. The system is not limited to four options only. For any given option the fan will encounter a variation in drive state. The time duration for which it is driven or not driven is controlled by the PWM signal. Controlling the duty cycle of the applied power will result in power savings. Duty cycle is defined as the ratio of the duration for which the fan is in on-drive state and the duration for which the fan is in off-drive state. The power management processor 114 has special hardware, which allows changing duty cycles quickly and applying the changed signal very rapidly to adapt to the changed environment of traffic intensity. This PWM signal is thus a function of the quantification of data traffic through the equipment. The system design can be made dependent on the resolution of optimal power control desired by the system designer.

The illustration in FIG. 9 can also be explained by using variable voltage fan system for design of ventilation systems. The pulse width modulated waveform can be used to generate a variable voltage, which directly regulates the speed of the ventilating fan. In this case the speed of the fan can be made variable to the applied voltage that is sourced over the PWM Link 116. This will be equivalent to applying the average voltage in different options to the cooling fan. As per the illustration of FIG. 9, the average voltage over the time period t will be the highest in Option D and lowest in Option A. For example, average voltage in Option B will be V/2, in Option D will be V, in Option C will be between V/2 and V, and will be less than V/2 in option A. Different voltage levels can be configured with fine resolutions to achieve precise power regulations. The system designer can design the resolution and precision as per the requirements of the system equipment.

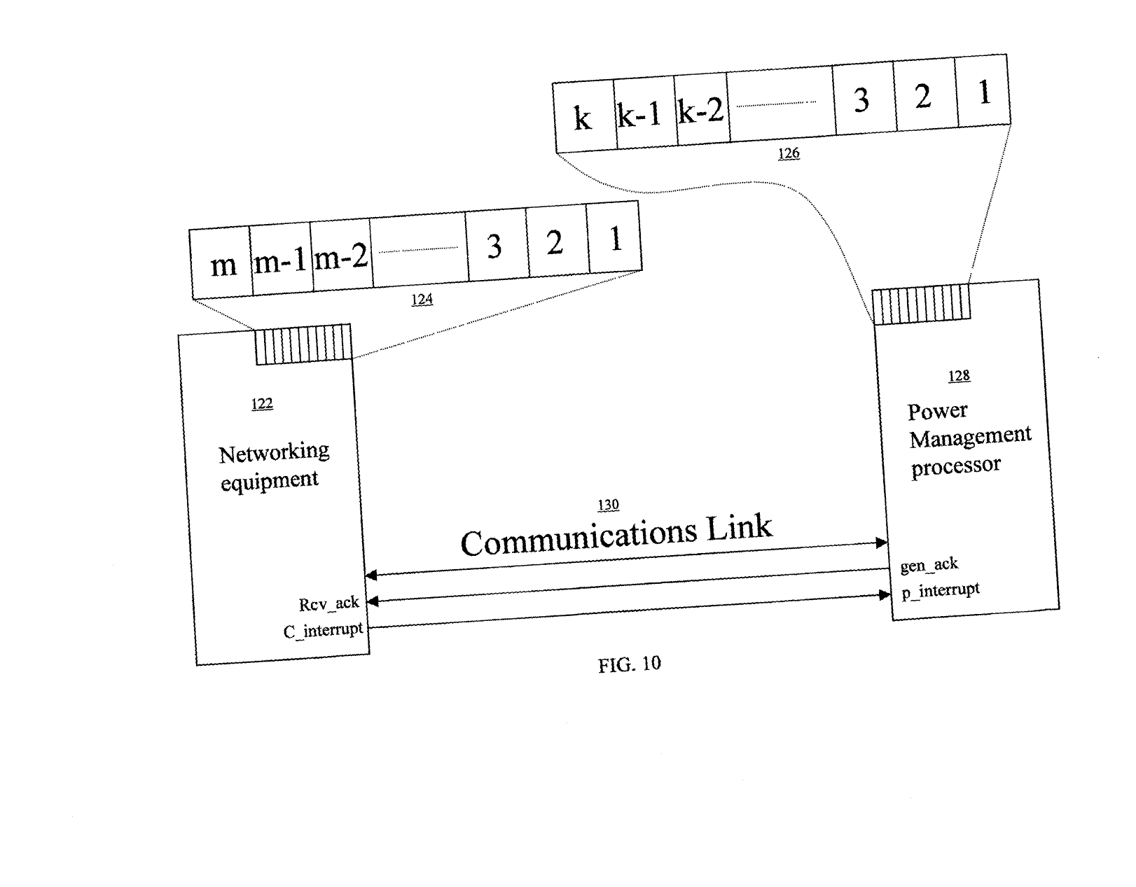

FIG. 10 is Communications link interface. The idea of this system design is to off-load the network processor from doing any power management function with respect to the ventilation system in the equipment. The power management processor is equipped specifically with pulse width modulation capability, which allows it to efficiently control the ventilation system. The communication between the network processor and the power management processor will be through a communication link. Whenever, the network processor 122 experiences change in traffic intensity, it can communicate the change to the power management processor 128 by updating the internal registers (register m 124 and register k 126 in the figure) and communicated over the communication link. Alternatively, the power management processor can check the data traffic intensity at periodic intervals. The power management processor will control the cooling and ventilation system to provide optimal ventilation depending on the data communicated in the registers. Energy conservation is achieved by optimal drive of the cooling and ventilation system in the computer communication equipment.

The data traffic that flows in the networking equipment is processed before being delivered to the destination. The computer networking equipment processors keep track of the intensity of traffic in any given time interval. The traffic intensity value is stored in the m register. The traffic intensity data in m register is communicated to power management processor as the control data. The traffic intensity can be quantified into m bit register as indicated in FIG. 10. The value of m can range from 8-bit to 16-bit or higher number of bits depending on the desired resolution of control. For example, an 8-bit representation would mean values from 00000000 to 11111111, which correspond to 0 to 255 in decimal representation. This 8-bit value can be transferred to power management processor on periodic basis or the networking equipment can generate an exception and request communication whenever it experiences sudden changes in traffic intensity levels. The values in the m register reside as values of k register in the power management processor assuming value of m is equal to value of k. The contents of m register in networking processor/equipment are communicated to power management processor over the communication link.

The power management processor interprets the data in the k register. The interpretation of values in k register is programmed in software that runs on the power management processor. Different variations of pulse widths are configured depending on the contents of k register. For example, assuming higher values in k register correspond to higher traffic intensity, then value of 11111111 in k register (for k=8) can correspond to option D of the PWM signals of FIG. 9. Similarly, the lowest value in k register of 00000000 can correspond to option A of FIG. 9. The intermediate values can be configured for option B or C. Multiple options can be programmed depending on the traffic intensity. 8-bit representation of k and m registers result in as many as 256 combinations.

An additional option for the m and k register can also include the location of the cooling fan. The cooling system in the networking equipment is distributed. Sometimes, few data channels could be doing higher data traffic intensity with few channels without any data traffic. In this situation the ventilation cooling can be reduced to extremely low levels near channels with very low data intensity levels. For example, a system with 8 fans can have a 3-bit representation ranging from 000 to 111, which corresponds to 0 to 7 in decimal numbers. This could be the 3 most significant bits in the m and k registers followed by rest of the bits for PWM pulse width control. This 3-bit value can be used to globally shut off undesired ventilation fan. For example, a value of 101 (5 in decimal) in the 3 most significant bits in m and k register could indicate to the power management processor to keep the cooling fan 5 in off state all the time.

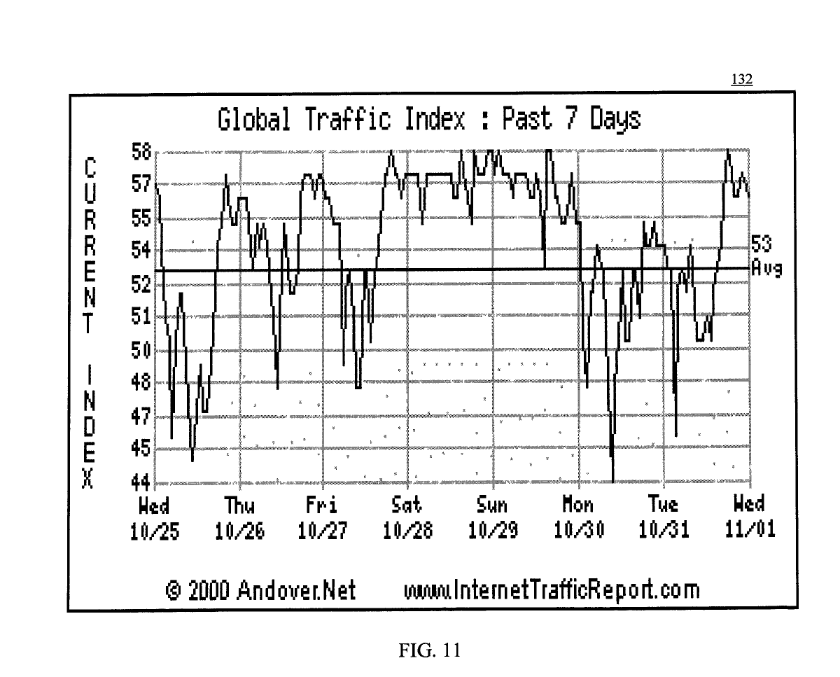

FIG. 11 is the plot of Internet traffic index 132. This graph shows a plot of data traffic over the Internet as a function of day and time. As evident from the graph, the traffic throughput goes through significant variations on any given day and time periods. The variations in usage pattern could also be dependent on the content that travels through the networking equipment. The content might be company specific intranet content or the content might be such that people access it globally. This invention seeks to use the traffic intensity patterns to design the system. The invention seeks to design energy efficient electronic equipment. The permission to use the data on Internet traffic report from Andover.net has been obtained.

The chart in FIG. 11 is a representation of global Internet traffic. Depending on the time zone for the equipment, the average networking equipment or system can experience almost a similar pattern of traffic density. This invention will use this information and process it to design adaptive control of ventilation and cooling system resulting in power savings.

This system described in FIG. 8, FIG. 9, FIG. 10, and FIG. 11 can be made part of the electronic equipment operating at high frequencies and which can handle very high quantities of data. This invention may be utilized without restriction as to the type of microprocessor used as power management processor. In particular, power management processor may be an 8-bit, 16-bit, 32 or 64-bit processor. The choice of processor is primarily dependent upon the amount of non-power management related functions that are to be supported by power management processor. Additional specialized circuitry can be added around the microprocessors to simplify generation of pulse width modulation waveforms.

The power management function and the power management processor can be integrated on the integrated circuit of computer networking equipment or the network processor. This can result in cost savings and integration of functionalities. The illustration in FIG. 8 is a system description for implementing optimal power efficient networking equipment. The function can also be achieved by integrating the pulse width modulation capability within the networking equipment. The function of generating variable voltage to drive cooling fans at variable speeds can also be made a part of networking equipment.

Reduction in ventilation fan speeds and the reduction in times for which the fan is in drive state also result in lower noise emissions. Because of the nature of networking equipment and proximity of networking engineers in the vicinity, lower noise emissions is an important consideration. The concepts of power management described here are also applicable for networking equipment that has Storage Area Network (SAN) or wireless networking components.

Savings in energy is an important consideration in selection of electronic devices especially in countries where energy systems are running at maximum capacity levels or in places where electrical energy is in short supply. The growth of Internet is directly related to the rate at which Internet equipment can be deployed. In many applications of the equipment, the deployment is conditional on the energy requirements of the equipment.

The preceding examples can be repeated with similar success by substituting the generically or specifically described components and operating conditions of this invention for those used in the preceding examples. Although the invention has been described in detail with particular reference to these preferred embodiments, other embodiments can achieve the same results. Variations and modifications of the present invention will be obvious to those skilled in the art and it is intended to cover all such modifications and equivalents. The entire disclosures of all references, applications, patents, and publications cited above, are hereby incorporated by reference.

### CONCLUSION, RAMIFICATIONS, AND SCOPE OF INVENTION

Accordingly, the reader will see that the system designed with energy conservation and power management in mind can use this invention to design systems that want to achieve energy conservation objective. The system uses network traffic intensity data levels coupled with pulse width management (PWM) technique to control cooling inside networking equipment. The function of power management processor can be implemented using a separate processor, which can perform micro-controller or digital signal processing (DSP) functions as well. The function of power management processor can be integrated on to the existing networking integrated circuits. Cooling fans contribute to significant noise levels when a series of networking equipment is deployed within a facility (like server-farm). Control of cooling systems will result in reduction in noise levels in the networking equipment facility. The invention can be applied to a heterogeneous system that could comprise of wired, storage, and wireless networking equipment.

I claim:

1. A method for energy conservation and power management in networking equipment that includes networking electronics, power management processor, and containing a plurality of cooling and ventilation systems each of which can be individually controlled with the application of time duration of voltage or voltage levels, said method comprising the steps of:
determining the intensity of data traffic within the networking equipment components;
storing the plurality of values representing the previously designed levels of operation of cooling and ventilation systems in direct correlation to network traffic level;
computing, the time duration of pulse width modulation waveform depending on the values representing the network traffic level; and
applying the pulse width modulated waveforms to the cooling and ventilation fans using power management processor.

2. A method of claim 1 wherein the said power management processor generating the pulse width modulation waveforms for the cooling and ventilating fans is an independent electronic component.

3. A method of claim 1 wherein the said power management processor generating the pulse width modulation waveform for cooling and ventilating fans is integrated within some other integrated circuit electronic component that is part of the networking electronics.

4. A method of claim 1 wherein the said power management processor functions are achieved by an integrated circuit component called Digital Signal Processor (DSP).

5. A method of claim 1 wherein the said power management processor functions are achieved by an integrated circuit component called Micro-controller.

6. A method of claim 1 wherein the said power management processor functions are built into a system called Storage Area Network (SAN) networking equipment.

7. A method of claim 1 wherein the said power management functions are built into a system called wireless networking equipment.

8. A method of claim 1 wherein the said power management functions are built into a heterogeneous networks system comprising of wired, storage, and wireless networking equipment.

9. A method of operating networking equipment having a power management processor and a plurality of cooling and ventilation systems, said method of comprising the steps of:
dynamically adapting the cooling and ventilation system to change the noise levels in the networking equipment vicinity.

10. A method of claim 9 to control the drive state of cooling system fans in the networking equipment facility.

11. A method of claim 9 wherein the networking equipment is a Storage Area Network (SAN) network equipment.

12. A method of claim 9 wherein the networking equipment is wireless networking equipment.

13. A method of claim 9 wherein the networking equipment is a heterogeneous networks system comprising of wired, storage, and wireless networking equipment.
